(19) United States
(12) Patent Application Publication
(10) Pub. No.: US 2014/0162101 A1
(43) Pub. Date: Jun. 12, 2014

(54) BATTERY MODULE

(71) Applicants: BYD COMPANY LIMITED, Shenzhen (CN); SHENZHEN BYD AUTO R&D COMPANY LIMITED, Shenzhen (CN)

(72) Inventors: Linglong WANG, Shenzhen (CN); Chenwei LENG, Shenzhen (CN); Yanfei ZHOU, Shenzhen (CN); Rui GAO, Shenzhen (CN); Haiping WU, Shenzhen (CN); Yining SONG, Shenzhen (CN)

(73) Assignees: BYD COMPANY LIMITED, Shenzhen (CN); SHENZHEN BYD AUTO R&D COMPANY LIMITED, Shenzhen (CN)

(21) Appl. No.: 14/181,528

(22) Filed: Feb. 14, 2014

Related U.S. Application Data
(63) Continuation of application No. PCT/CN2012/079406, filed on Jul. 31, 2012.

(30) Foreign Application Priority Data
Aug. 17, 2011 (CN) 201110235424.2

(51) Int. Cl. H01M 10/42

(52) U.S. Cl. CPC H01M 10/4285
USPC 429/91; 429/90

(57) ABSTRACT

A battery module comprises a battery pack including a plurality of cells and a plurality of connectors to electrically connect adjacent cells respectively; a case housing the battery pack; and a sampling unit fixed to the case and including: a BIC module fixed onto the case; a wiring trough fixed onto the case; a signal sampling terminal; and a sampling wire disposed within the wiring trough and having a first end electrically connected to the BIC module and a second end electrically connected to the signal sampling terminal.

### CROSS REFERENCE TO RELATED APPLICATIONS

This application is a continuation application of International Application No. PCT/CN2012/079406, filed on Jul. 31, 2012, which claims priority and benefits of Chinese Patent Application No. 201110235424.2, filed with State Intellectual Property Office, P. R. C. on Aug. 17, 2011. The entire content of above-referenced applications is incorporated herein by reference.

### FIELD

The present disclosure generally relates to a technical field of battery, more particularly, to a battery module for an electric vehicle.

### BACKGROUND ART

In order to reduce vehicle emission, batteries are used as power resources of vehicles instead of petrol, and hybrid vehicle and pure electric vehicles have been manufactured.

The cruising mileage of an electric vehicle, determined largely by the battery pack the vehicle carries, is very important for the performance of the vehicle. Therefore, the key to increasing the cruising mileage of an electric vehicle lies in arranging as many batteries as possible within the limited space of the electric vehicle.

In most of electric vehicles, sampling wires inside of the battery pack are bundled together. Such bundling of wires may cause problems if, due to lack of planning, some of the wires cross over others, such that it can easily cause a short circuit if part of wires' insulation is broken. Moreover, a disorderly arrangement of the wires can also make maintenance work difficult, especially if the battery pack includes a plurality of cells.

### SUMMARY OF THE DISCLOSURE

Embodiments of the present disclosure seek to solve at least one of the problems existing in the prior art to at least some extent, or at least to provide consumers with a useful alternative.

Embodiments of the present disclosure provide a battery module with an external wiring trough to hold the sampling wires, wherein the sampling wires can be arranged in the wiring trough in an orderly fashion, thereby minimizing the risk of short circuit.

The battery module according to embodiments of the present disclosure comprises: a battery pack including a plurality of cells and a plurality of connectors to electrically connect adjacent cells respectively; a case housing the battery pack; and a sampling unit fixed to the case and including: a BIC (battery information control) module fixed onto the case; a wiring trough fixed onto the case; a signal sampling terminal; and a sampling wire disposed within the wiring trough and having a first end electrically connected to the BIC module and a second end electrically connected to the signal sampling terminal.

With the battery module according to embodiments of the present disclosure, the wiring trough can be attached closely to the battery module, so that the proper positioning of the sampling wire inside the wiring trough can be substantially maintained, and the number of the sampling wires, as well as the cost, can be reduced. Additionally, the wires can be arranged in an orderly fashion, and risk of short circuit due to the crossing of the wires can be minimized.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference the accompanying drawings, in which:

FIG. 1 is a schematic view of a battery module according to an embodiment of the present disclosure;

FIG. 2 is a schematic view of a wiring trough of a battery module according to an embodiment of the present disclosure;

FIG. 3 is a partially enlarged view of part A of FIG. 2; and

FIG. 4 is a schematic view of a case of a battery module according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also, it is to be understood that phraseology and terminology used herein with reference to device or element orientation (such as, for example, terms like “central,” “upper,” “lower,” “front,” “rear,” and the like) are only used to simplify description of the present invention, and do not alone indicate or imply that the device or element referred to must have a particular orientation.

A battery module according to an embodiment of the present disclosure, comprises: a battery pack, a case housing the battery pack, and a sampling unit. The battery pack includes a plurality of cells and a plurality of connectors to electrically connect adjacent cells respectfully. The sampling unit is fixed to the case and includes: a BIC module fixed onto the case, a wiring trough fixed onto the case, a signal sampling terminal, and a sampling wire disposed within the wiring trough and having a first end electrically connected to the BIC module and a second end electrically connected to the signal sampling terminal.

In a further embodiment of the present disclosure, the wiring trough has a slot to arrange the sampling wire and a lead-out groove to lead out the sampling wire. Specifically, the lead-out groove may have a U shape. The slot and lead-out groove may also be formed in each of inner (e.g. with an opening facing inward) and outer (e.g. with an opening facing outward) sides of the wiring trough. In some embodiments, the sampling wire can be fixed into the wiring trough by an adhesive and led out via the lead-out groove.

In a further embodiment of the present disclosure, the signal sampling terminal includes a voltage sampling terminal electrically connected to the connector and a temperature sampling terminal connected to the connector. Specifically, the sampling wire may include a voltage sampling wire connected to the voltage sampling terminal and a temperature sampling wire connected to the temperature sampling terminal. The slot may also include a voltage sampling wire slot formed on the inner side of the wiring trough and a temperature sampling wire slot formed on the outer side of the wiring trough, wherein the voltage sampling wire is fixed into the voltage sampling wire slot, and the temperature sampling wire is fixed into the temperature sampling wire slot.

In a further embodiment of the present disclosure, an installation unit is disposed on the case, and the wiring trough is mounted onto the installation unit. Specifically, the installation unit may include a supporting part and a positioning part, wherein the wiring trough can be received in the supporting part and positioned by the positioning part. In some embodiments, the wiring trough can be bonded to the installation unit.

In a further embodiment of the present disclosure, the BIC module includes a housing and a circuit board disposed inside the housing and electrically connected to the sampling wire.

In a further embodiment of the present disclosure, a fixing part to fix the BIC module to the case is disposed on the case. Specifically, a plurality of threaded holes is formed in the fixing part, and the fixing part is mounted to the case by screws. The BIC module is fixed to the fixing part by a snap-fit structure disposed on the fixing part.

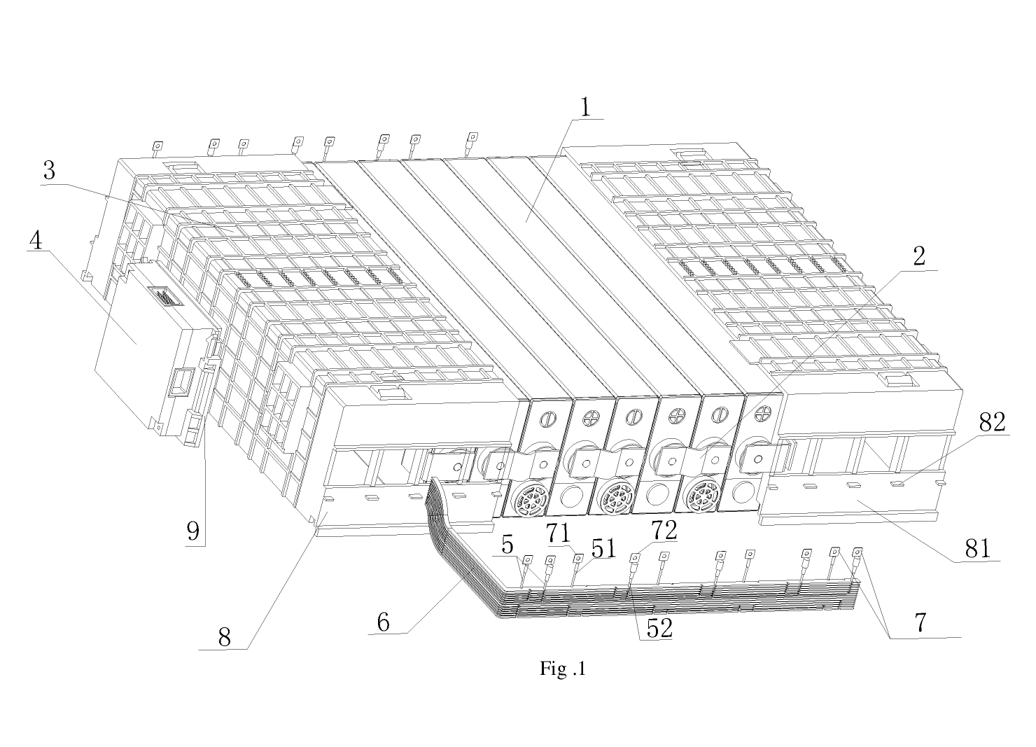

The battery module according to embodiments of the present disclosure will be described with reference of FIGS. 1 to 5 below.

As shown in FIG. 1, a battery module according to embodiments of the present disclosure comprises a battery pack and a case 3.

The battery pack includes a plurality of cells 1 and a plurality of connectors 2 configured to electrically connect adjacent cells 1 respectively.

The case 3 wraps the battery pack. The structure and combination of the battery pack and case 3 are well known in the art. For instance, the connectors 2 connect the cells in series or in parallel to form the battery pack, while the case 3 wraps the battery pack. Therefore, the details of the battery and case will be omitted here.

Moreover, the battery module according to embodiments of the present disclosure also comprises a sampling unit fixed onto the case 3. The sampling unit includes: a BIC (battery information collection) module 4, sampling wires 5, a wiring trough 6 and a signal sampling terminal 7. The BIC module 4 may be fixed onto the case 3. The wiring trough 6 may also be fixed onto the case. The sampling wires 5 are disposed within the wiring trough 6 and may have a first end electrically connected to the BIC module 4 and a second end electrically connected to the signal sampling terminal 7.

In this embodiment, the signal sampling terminal 7 can collect related signals of the battery module, convert these related signals into electric signals and convey the signals to the BIC module 4 via the sampling wires 5, so that various conditions of the battery module can be monitored.

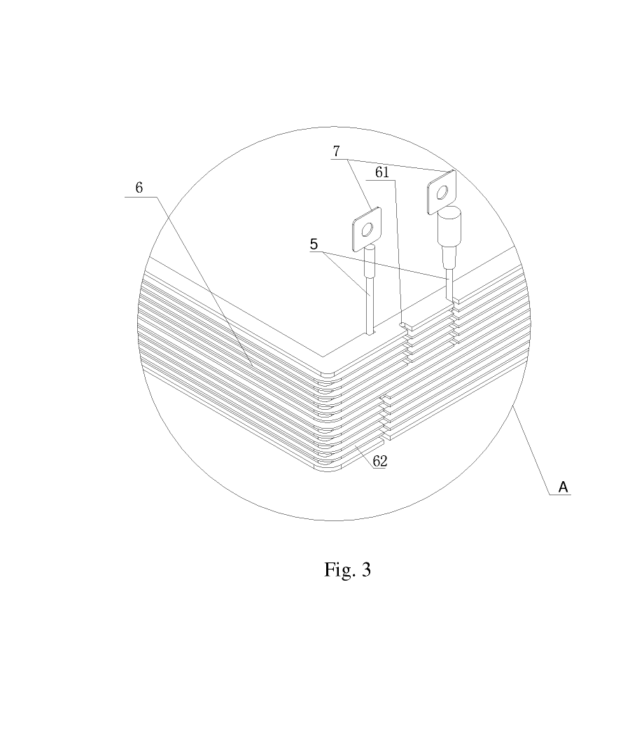

In the embodiments of the present disclosure, the wiring trough 6 has slots 62 to arrange the sampling wire 5 and lead-out grooves 61 to lead out the sampling wires 5, as shown in FIG. 3. The wiring trough 6 may be molded integrally. In the molding process, a dimension of the slot 62 and a location of the lead-out groove 61 may be determined based on the requirements of structures and dimensions of the battery module and the sampling wire 5. The wiring trough 6 may be manufactured via other manners.

In the embodiments of the present disclosure, the lead-out groove 61 may have various shapes such as a square shape, a V shape or a U shape. In a preferable embodiment of the present disclosure, the lead-out groove 61 has a U shape, because the U shaped lead-out groove has an arcuate end which can be advantageous for arranging and leading out the sampling wire 5.

In the embodiments of the present disclosure, the openings of the slot 62 and the lead-out groove 61 may be on the same side or on both sides (e.g. both inward facing and outward facing) of the wiring trough 6. In the embodiment shown in FIG. 3, the slot 62 and lead-out groove 61 can be formed on each of inner and outer sides of the wiring trough 6, so that the number of the wiring trough 6 and the size of the battery module can be reduced.

In the embodiments of the present disclosure, the sampling wire 5 may be fixed into the wiring trough by an adhesive and led out via the lead-out groove 61. Alternatively, the sampling wire 5 may also be fixed in the slot 62 via snap-fit, clamping structures, or via other means.

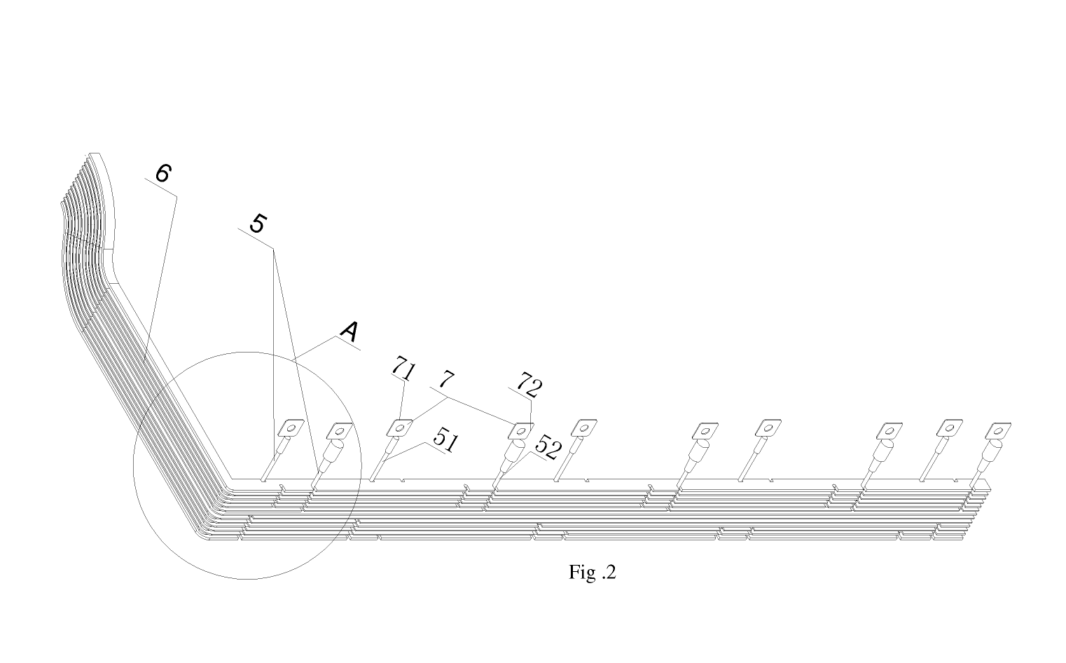

In the embodiments of the present disclosure, various terminals may be adopted as the signal sampling terminal 7 based on different requirements of various sampling signals. For example, signal sampling terminal 7 can be adopted as terminals for sampling voltage, current and temperature. In the embodiments as shown in FIGS. 1 and 2, the signal sampling terminal 7 includes a voltage sampling terminal 71 and a temperature sampling terminal 72. Both sampling terminals 71 and 72 may be electrically connected to the connector 2. The temperature sampling terminal 72 may be connected to the connector 2 via a connection structure having a good thermal conductivity. The temperature sampling terminal 72 may also be located close to the connector 2.

In the embodiments of the present disclosure, the sampling wire 5 may include wires for various sampling signals, such as voltage sampling wire, current sampling wire and temperature sampling wire. In the embodiments as shown in FIGS. 2-3, the sampling wire 5 includes a voltage sampling wire 51 electrically connected to the voltage sampling terminal 71, and a temperature sampling wire 52 electrically connected to the temperature sampling terminal 72.

In the embodiments of the present disclosure, the slot 62 may also include slots for various sampling wires, such as voltage sampling wire slot, current sampling wire slot and temperature sampling wire slot. The slot 62 may include a voltage sampling wire slot formed on one side of the wiring trough 6 (e.g. with opening facing inward of the wiring trough 6) and a temperature sampling wire slot formed on another side of the wiring trough 6 (e.g. with opening facing outward of the wiring trough 6). The voltage sampling wire 51 can be fixed into the voltage sampling wire slot, and the temperature sampling wire 52 can be fixed into the temperature sampling wire slot.

In the embodiments of the present disclosure, the sampling wire 5 may be fixed via different manners. In the embodiment as shown in FIG. 3, the lead-out groove 61 and the slot 62 may be formed on each of both inner and outer sides of the wiring trough 6. Accordingly, the voltage sampling wire 51 is fixed into the slot 62 formed on the inner side of the wiring trough 6 and the temperature sampling wire 52 is fixed into the slot 62 formed on the outer side of the wiring trough 6, such that the voltage sampling wire 51 is fixed into the voltage sampling wire slot on the side adjacent to the battery pack, while the temperature sampling wire 52 is fixed into the temperature sampling wire slot on the side away from the battery pack. The arrangement of the sampling wire 5 in the wiring trough 6 may be determined according to specific requirements and various structures of the aforementioned elements.

In the embodiments of the present disclosure, an installation unit 8 can be formed on the case 3 to mount the wiring trough 6, as shown in FIG. 1. The wiring trough 6 is mounted onto the installation unit 8. The shape and location of the installation unit 8 may depend on installation requirements of the location and width of the wiring trough 6. In the embodiment as shown in FIG. 1, the installation unit 8 is disposed on an edge of the case 3 so that it is easy to mount the wiring trough 6 onto the installation unit 8.

The installation unit 8 may include a supporting part 81 and a positioning part 82, as shown in FIG. 1. The wiring trough 6 can be received in the supporting part 81 and positioned by the positioning part 82. In the embodiments of the present disclosure, the wiring trough 6 is preferably bonded to the installation unit 8. Alternatively, the wiring trough 6 may also be fixed onto the installation unit 8 via screws, or via other manners.

In the embodiments of the present disclosure, a BIC module is a kind of bus interface module and includes a housing and a circuit board disposed inside the housing. The housing may be used to insulate the BIC module, while the circuit board can be electrically connected to the sampling wire to collect, process and transmit the sampled signals. The structure and function of a BIC module is appreciated by those skilled in the art, so that details thereof are omitted here.

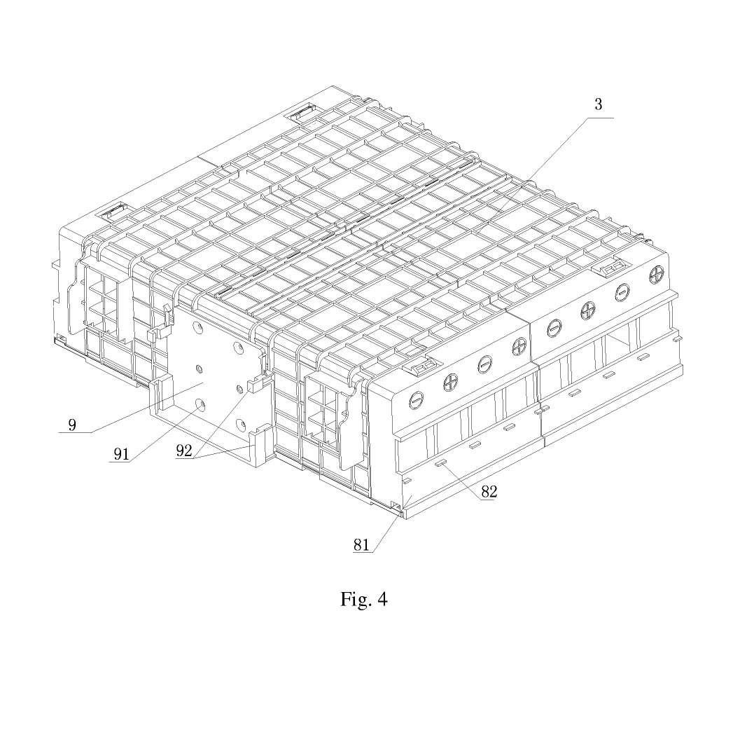

In a preferred embodiment shown in FIGS. 1 and 4, a BIC module 4 is fixed to a fixing part 9, while the fixing part 9 is disposed on the case 3. Alternatively, the BIC module 4 may also be fixed onto the case 3 by screw, by bonding via a super adhesive, or by other manners.

In the preferred embodiment as shown in FIG. 4, a plurality of threaded holes 91 is formed in the fixing part 9, and the fixing part 9 may be mounted to the case 3 by screws (not shown). Moreover, the BIC module 4 also has a snap-fit structure 92, such that the BIC module 4 can be fixed to the fixing part 9 by the snap-fit structure 92. The BIC module 4 may also be fixed to the fixing party by other manners.

With the battery module according to embodiments of the present disclosure, the wiring trough can be attached closely to the battery module, so that the proper positioning of the sampling wire inside the wiring trough can be substantially maintained, and the number of sampling wires, as well as the cost, can be reduced. In addition, the sampling wires can be arranged in the wiring trough in an orderly fashion, thereby minimizing the risk of short circuit.

Reference throughout this specification to “an embodiment,” “some embodiments,” “one embodiment”, “another example,” “an example,” “a specific examples,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example, “in an example,” “in a specific examples,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A battery module, comprising:
a battery pack including a plurality of cells and a plurality of connectors to electrically connect adjacent cells;
a case housing the battery pack; and
a sampling unit fixed to the case and including:
a battery information control (BIC) module fixed onto the case;
a wiring trough fixed onto the case;
a signal sampling terminal; and
a sampling wire disposed within the wiring trough and having a first end electrically connected to the BIC module and a second end electrically connected to the signal sampling terminal.

2. The battery module as set forth in claim 1, wherein the wiring trough has a slot to arrange the sampling wire and a lead-out groove to lead out the sampling wire.

3. The battery module as set forth in claim 2, wherein the lead-out groove has a U shape.

4. The battery module as set forth in claim 2, wherein the slot and lead-out groove are formed in each of inner and outer sides of the wiring trough respectively .

5. The battery module as set forth in claim 2, wherein the sampling wire is fixed into the wiring trough by an adhesive and led out via the lead-out groove.

6. The battery module as set forth in claim 1, wherein the signal sampling terminal includes a voltage sampling terminal electrically connected to the connector and a temperature sampling terminal connected to the connector.

7. The battery module as set forth in claim 6, wherein the sampling wire includes a voltage sampling wire connected to the voltage sampling terminal and a temperature sampling wire connected to the temperature sampling terminal.

8. The battery module as set forth in claim 7, wherein the slot includes a voltage sampling wire slot formed in the inner side of the wiring trough and a temperature sampling wire slot formed in the outer side of the wiring trough, the voltage sampling wire is fixed into the voltage sampling wire slot, and the temperature sampling wire is fixed into the temperature sampling wire slot.

9. The battery module as set forth in claim 1, wherein an installation unit is disposed on the case, and the wiring trough is mounted onto the installation unit.

10. The battery module as set forth in claim 9, wherein the installation unit includes a supporting part and a positioning part, the wiring trough is received in the supporting part and positioned by the positioning part.

11. The battery module as set forth in claim 9, wherein the wiring trough is bonded to the installation unit.

12. The battery module as set forth in claim 1, wherein the BIC module includes a housing and a circuit board disposed inside the housing and electrically connected to the sampling wire.

13. The battery module as set forth in claim 1, wherein a fixing part for fixing the BIC module is disposed on the case.

14. The battery module as set forth in claim 13, wherein a plurality of threaded holes is formed in the fixing part, and the fixing part is mounted to the case by screws.

15. The battery module as set forth in claim 13, wherein the BIC module is fixed to the fixing part by a snap-fit structure disposed on the fixing part.
